(19) United States
(12) Patent Application Publication
(10) Pub. No.: US 2015/0311791 A1
(43) Pub. Date: Oct. 29, 2015

(54) SINGLE INDUCTOR MULTIPLE OUTPUT DC-DC CONVERTOR

(71) Applicant: Taiwan Semiconductor Manufacturing Company Limited, Hsin-Chu (TW)

(72) Inventors: Chien-Chung Tseng, Zhubei City (TW); Alan Roth, Leander, TX (US); Eric Soenen, Austin, TX (US)

(21) Appl. No.: 14/261,457

(22) Filed: Apr. 25, 2014

(51) Int. Cl. H02M 3/158; H02M 1/36

(52) U.S. Cl. CPC H02M 3/158; H02M 1/36

(57) ABSTRACT

A single inductor multiple output (SIMO) DC-DC convertor is provided. The SIMO DC-DC convertor is configured to establish a first DC voltage at a first node and establish a second DC voltage at a second node. A first switch of the SIMO DC-DC convertor is activated when a voltage at the first node is below the first DC voltage. A second switch of the SIMO DC-DC convertor is activated when a voltage at the second node is below the second DC voltage. The first switch is deactivated when the voltage at the first node is not below the first DC voltage. The second switch is deactivated when the voltage at the second node is not below the second DC voltage. The first switch and the second switch, and other switches in the SIMO DC-DC converter, are activated in any order and independently of one another to establish desired node voltages.

### BACKGROUND

A single inductor multiple output (SIMO) DC-DC convertor is an electronic component that uses a single inductor to generate or output different voltages.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an illustration of a circuit, in accordance with some embodiments.

FIG. 2 illustrates a flow diagram of a method, according to some embodiments.

FIG. 3 illustrates a flow diagram of a method, according to some embodiments.

FIG. 4 illustrates a flow diagram of a method, according to some embodiments.

FIG. 5 illustrates an example computer-readable medium or computer-readable device comprising processor-executable instructions configured to embody one or more of the provisions set forth herein, according to various embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some embodiments, a single inductor multiple output (SIMO) DC-DC convertor is provided. In some embodiments, the SIMO DC-DC convertor is configured to apply a plurality of DC voltages to a plurality of nodes. In some embodiments, the plurality of nodes comprises 50 nodes. In some embodiments, the plurality of nodes comprises more than 50 nodes. In some embodiments, the plurality of nodes comprises fewer than 50 nodes. In some embodiments, the SIMO DC-DC convertor is configured to establish a first DC voltage at a first node of the plurality of nodes and to establish a second DC voltage at a second node of the plurality of nodes. In some embodiments, the first DC voltage is not equal to the second DC voltage. In some embodiments, switches of the SIMO DC-DC converter are activated and deactivated in any order and independently of one another to establish desired DC voltages at different nodes.

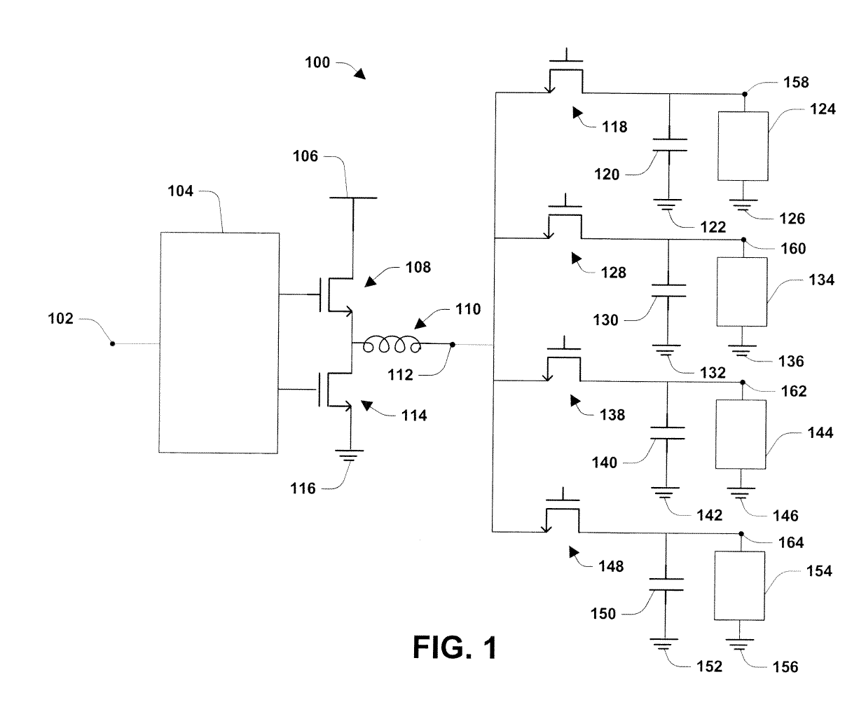

A SIMO DC-DC convertor, according to some embodiments, is illustrated in FIG. 1. In some embodiments, the SIMO DC-DC convertor comprises a first node 158, a second node 160, a third node 162, a fourth node 164, a fifth node 102, a sixth node 112, a first circuit 104, a first transistor 108, a second transistor 114, an inductor 110, a first switch 118, a second switch 128, a third switch 138, a fourth switch 148, a first capacitor 120, a second capacitor 130, a third capacitor 140 and a fourth capacitor 150. In some embodiments, the SIMO DC-DC convertor is connected to a first load 124, a second load 134, a third load 144 and a fourth load 154. In some embodiments, the fifth node 102 is connected to the first circuit 104. In some embodiments, the first circuit 104 is connected to a gate of the first transistor 108. In some embodiments, the first circuit 104 is connected to a gate of the second transistor 114. In some embodiments, a drain of the first transistor 108 is connected to a first voltage source 106. In some embodiments, a source of the first transistor 108 is connected to a second side of the inductor 110. In some embodiments, the second side of the inductor 110 is connected to a drain of the second transistor 114. In some embodiments, a source of the second transistor 114 is connected to a second voltage source 116. In some embodiments, a first side of the inductor 110 is connected to the fifth node 112. In some embodiments, the fifth node 112 is connected to a first side of the first switch 118, a first side of the second switch 128, a first side of the third switch 138 and a first side of the fourth switch 148. In some embodiments, a second side of the first switch 118 is connected to a first side of the first capacitor 120. In some embodiments, a second side of the first capacitor 120 is connected to a third voltage source 122. In some embodiments, the first side of the first capacitor 120 is connected to the first node 158. In some embodiments, the first node 158 is connected to the first load 124. In some embodiments, the first load 124 is connected to a fourth voltage source 126. In some embodiments, a second side of the second switch 128 is connected to a first side of the second capacitor 130. In some embodiments, a second side of the second capacitor 130 is connected to a fifth voltage source 132. In some embodiments, the first side of the second capacitor 130 is connected to the second node 160. In some embodiments, the second node 160 is connected to the second load 134. In some embodiments, the second load 134 is connected to a sixth voltage source 136. In some embodiments, a second side of the third switch 138 is connected to a first side of the third capacitor 140. In some embodiments, a second side of the third capacitor 140 is connected to a seventh voltage source 142. In some embodiments, the first side of the third capacitor 140 is connected to the third node 162. In some embodiments, the third node 162 is connected to the third load 144. In some embodiments, the third load 144 is connected to an eighth voltage source 146. In some embodiments, a second side of the fourth switch 148 is connected to a first side of the fourth capacitor 150. In some embodiments, a second side of the fourth capacitor 150 is connected to a ninth voltage source 152. In some embodiments, the first side of the fourth capacitor 150 is connected to the fourth node 164. In some embodiments, the fourth node 164 is connected to the fourth load 154. In some embodiments, the fourth load 154 is connected to a tenth voltage source 156. In some embodiments, a voltage source corresponds to ground.

In some embodiments, the first voltage source 106 supplies a voltage of 5 V or similar. In some embodiments, the first voltage source 106 supplies a voltage of 3.3 V or similar. In some embodiments, the first voltage source 106 supplies a voltage less than 5 V. In some embodiments, the first voltage source 106 supplies a voltage greater than 5 V. In some embodiments, the second voltage source 116 supplies a voltage less than 5 V. In some embodiments, the second voltage source 116 supplies a voltage between 0 V and 5 V. In some embodiments, the second voltage source 116 supplies a voltage of about 0 V. In some embodiments, the third voltage source 122 supplies a voltage of about 0 V. In some embodiments, the fourth voltage source 126 supplies a voltage of about 0 V. In some embodiments, the fifth voltage source 132 supplies a voltage of about 0 V. In some embodiments, the sixth voltage source 136 supplies a voltage of about 0 V. In some embodiments, the seventh voltage source 142 supplies a voltage of about 0 V. In some embodiments, the eighth voltage source 146 supplies a voltage of about 0 V. In some embodiments, the ninth voltage source 152 supplies a voltage of about 0 V. In some embodiments, the tenth voltage source 156 supplies a voltage of about 0 V.

In some embodiments, the first switch 118 comprises a transistor. In some embodiments, the first switch 118 comprises an NMOS transistor. In some embodiments, the first switch 118 comprises more than one transistor. In some embodiments, the second switch 128 comprises a transistor. In some embodiments, the second switch 128 comprises an NMOS transistor. In some embodiments, the second switch 128 comprises more than one transistor. In some embodiments, the third switch 138 comprises a transistor. In some embodiments, the third switch 138 comprises an NMOS transistor. In some embodiments, the third switch 138 comprises more than one transistor. In some embodiments, the fourth switch 148 comprises a transistor. In some embodiments, the fourth switch 148 comprises more than one transistor.

In some embodiments, the first circuit 104 is configured to receive a pulse-width modulation (PWM) signal at the fifth node 102. In some embodiments, the PWM signal has a PWM signal voltage that switches between a first voltage and a second voltage. In some embodiments, the first voltage is equal to 5 V or similar. In some embodiments, the first voltage is between 4 V and 6 V. In some embodiments, the first voltage is equal to 3.3 V or similar. In some embodiments, the first voltage is less than 5 V. In some embodiments, the second voltage is equal to 0 V or similar. In some embodiments, the first voltage is between 0 V and 2 V. In some embodiments, when the PWM signal voltage is equal to the first voltage, the first circuit 104 is configured to activate the first transistor 108 and deactivate the second transistor 114. In this way, the second side of the inductor 110 is connected to the first voltage source 106 and is disconnected from the second voltage source 116. In some embodiments, when the PWM signal voltage is equal to the second voltage, the first circuit 104 is configured to activate the second transistor 114 and deactivate the first transistor 108. In this way, the second side of the inductor 110 is connected to the second voltage source 116 and is disconnected from the first voltage source 106. In some embodiments, when the SIMO DC-DC convertor is turned on, a duty cycle of the PWM signal is configured such that a voltage at the sixth node 112 increases at a desired rate, with a limited inrush current flowing through the inductor 112.

In some embodiments, when the first switch 118 is activated, the first node 158 is connected to the sixth node 112. In some embodiments, when the second switch 128 is activated, the second node 160 is connected to the sixth node 112. In some embodiments, when the third switch 138 is activated, the third node 162 is connected to the sixth node 112. In some embodiments, when the fourth switch 148 is activated, the fourth node 164 is connected to the sixth node 112.

In some embodiments, the first load 124 is a circuit to which the SIMO DC-DC convertor is connected. In some embodiments, the second load 134 is a circuit to which the SIMO DC-DC convertor is connected. In some embodiments, the third load 144 is a circuit to which the SIMO DC-DC convertor is connected. In some embodiments, the fourth load 154 is a circuit to which the SIMO DC-DC convertor is connected.

In some embodiments, the first capacitor 120 is configured to store an amount of electric charge based upon a charge residing at the first node 158. In some embodiments, the first capacitor 120 is configured to resist a voltage change at the first node 158. In some embodiments, the second capacitor 130 is configured to store an amount of electric charge based upon a charge residing at the second node 160. In some embodiments, the second capacitor 130 is configured to resist a voltage change at the second node 160. In some embodiments, the third capacitor 140 is configured to store an amount of electric charge based upon a charge residing at the third node 162. In some embodiments, the third capacitor 140 is configured to resist a voltage change at the third node 162. In some embodiments, the fourth capacitor 150 is configured to store an amount of electric charge based upon a charge residing at the fourth node 164. In some embodiments, the fourth capacitor 150 is configured to resist a voltage change at the fourth node 164.

In some embodiments, the SIMO DC-DC convertor is configured to establish a first DC voltage at the first node 158. In some embodiments, the SIMO DC-DC convertor is configured to establish a second DC voltage at the second node 160. In some embodiments, the SIMO DC-DC convertor is configured to establish a third DC voltage at the third node 162. In some embodiments, the SIMO DC-DC convertor is configured to establish a fourth DC voltage at the fourth node 164.

In some embodiments, a second circuit is connected to the first node 158, to the second node 160, to the third node 162 and to the fourth node 164. In some embodiments, the second circuit is configured to monitor a voltage at the first node 158. In some embodiments, the second circuit is configured to monitor a voltage at the second node 160. In some embodiments, the second circuit is configured to monitor a voltage at the third node 162. In some embodiments, the second circuit is configured to monitor a voltage at the fourth node 164.

In some embodiments, the second circuit is connected to the first switch 118, to the second switch 128, to the third switch 138 and to the fourth switch 148. In some embodiments, the second circuit is configured to activate the first switch 118 when the voltage at the first node 158 is below the first DC voltage. In some embodiments, the second circuit is configured to activate the second switch 128 when the voltage at the second node 160 is below the second DC voltage. In some embodiments, the second circuit is configured to activate the third switch 138 when the voltage at the third node 162 is below the third DC voltage. In some embodiments, the second circuit is configured to activate the fourth switch 148 when the voltage at the fourth node 164 is below the fourth DC voltage.

In some embodiments, the second circuit is configured to deactivate the first switch 118 when the voltage at the first node 158 is not below the first DC voltage. In some embodiments, the second circuit is configured to deactivate the second switch 128 when the voltage at the second node 160 is not below the second DC voltage. In some embodiments, the second circuit is configured to deactivate the third switch 138 when the voltage at the third node 162 is not below the third DC voltage. In some embodiments, the second circuit is configured to deactivate the fourth switch 148 when the voltage at the fourth node 164 is not below the fourth DC voltage.

In some embodiments, the SIMO DC-DC convertor is turned on at a first time. In some embodiments, the voltage at the first node 158 is equal to 0 V at the first time. In some embodiments, the voltage at the first node 158 is less than the first DC voltage at the first time. In some embodiments, the voltage at the second node 160 is equal to 0 V at the first time. In some embodiments, the voltage at the second node 160 is less than the second DC voltage at the first time. In some embodiments, the voltage at the third node 162 is equal to 0 Vat the first time. In some embodiments, the voltage at the third node 162 is less than the third DC voltage at the first time. In some embodiments, the voltage at the fourth node 164 is equal to 0 V at the first time. In some embodiments, the voltage at the fourth node 164 is less than the fourth DC voltage at the first time.

In some embodiments, the first switch 118 is activated at the first time. In some embodiments, the second switch 128 is activated at the first time. In some embodiments, the third switch 138 is activated at the first time. In some embodiments, the fourth switch 148 is activated at the first time. In some embodiments, the second DC voltage is greater than the first DC voltage, the first DC voltage is greater than the third DC voltage and the third DC voltage is greater than the fourth DC voltage.

In some embodiments, the voltage at the fourth node 164 reaches the fourth DC voltage at a second time. In some embodiments, the fourth switch 148 is deactivated at the second time. In some embodiments, the voltage at the first node 158 is less than the first DC voltage at the second time. In some embodiments, the first switch 118 remains activated at the second time. In some embodiments, the voltage at the second node 160 is less than the second DC voltage at the second time. In some embodiments, the second switch 128 remains activated at the second time. In some embodiments, the voltage at the third node 162 is less than the third DC voltage at the second time. In some embodiments, the third switch 138 remains activated at the second time.

In some embodiments, the voltage at the third node 162 reaches the third DC voltage at a third time. In some embodiments, the third switch 138 is deactivated at the third time. In some embodiments, the voltage at the fourth node 164 is not below the fourth DC voltage at the third time. In some embodiments, the fourth switch 148 remains deactivated at the third time. In some embodiments, the voltage at the first node 158 is less than the first DC voltage at the third time. In some embodiments, the first switch 118 remains activated at the third time. In some embodiments, the voltage at the second node 160 is less than the second DC voltage at the third time. In some embodiments, the second switch 128 remains activated at the third time.

In some embodiments, the voltage at the first node 158 reaches the first DC voltage at a fourth time. In some embodiments, the first switch 118 is deactivated at the fourth time. In some embodiments, the voltage at the fourth node 164 is not below the fourth DC voltage at the fourth time. In some embodiments, the fourth switch 148 remains deactivated at the fourth time. In some embodiments, the voltage at the third node 162 is not below the third DC voltage at the fourth time. In some embodiments, the third switch 138 remains deactivated at the fourth time. In some embodiments, the voltage at the second node 160 is less than the second DC voltage at the fourth time. In some embodiments, the second switch 128 remains activated at the fourth time.

In some embodiments, the voltage at the second node 160 reaches the second DC voltage at a fifth time. In some embodiments, the second switch 128 is deactivated at the fifth time. In some embodiments, the voltage at the fourth node 164 is not below the fourth DC voltage at the fifth time. In some embodiments, the fourth switch 148 remains deactivated at the fifth time. In some embodiments, the voltage at the third node 162 is not below the third DC voltage at the fifth time. In some embodiments, the third switch 138 remains deactivated at the fifth time. In some embodiments, the voltage at the first node 158 is not below the first DC voltage at the fifth time. In some embodiments, the first switch 118 remains deactivated at the fifth time.

In some embodiments, the SIMO DC-DC convertor is turned on at a sixth time. In some embodiments, the voltage at the first node 158 is equal to 0 V at the sixth time. In some embodiments, the voltage at the first node 158 is less than the first DC voltage at the sixth time. In some embodiments, the voltage at the second node 160 is equal to 0 V at the sixth time. In some embodiments, the voltage at the second node 160 is less than the second DC voltage at the sixth time. In some embodiments, the voltage at the third node 162 is equal to 0 V at the sixth time. In some embodiments, the voltage at the third node 162 is less than the third DC voltage at the sixth time. In some embodiments, the voltage at the fourth node 164 is equal to 0 V at the sixth time. In some embodiments, the voltage at the fourth node 164 is less than the fourth DC voltage at the sixth time.

In some embodiments, the first switch 118 is activated at the sixth time. In some embodiments, the second switch 128 is activated at the sixth time. In some embodiments, the third switch 138 is activated at the sixth time. In some embodiments, the fourth switch 148 is activated at the sixth time. In some embodiments, the second DC voltage is greater than the first DC voltage, the first DC voltage is greater than the third DC voltage and the third DC voltage is greater than the fourth DC voltage.

In some embodiments, the voltage at the fourth node 164 reaches the fourth DC voltage at a seventh time. In some embodiments, the fourth switch 148 is deactivated at the seventh time. In some embodiments, the voltage at the first node 158 is less than the first DC voltage at the seventh time. In some embodiments, the first switch 118 remains activated at the seventh time. In some embodiments, the voltage at the second node 160 is less than the second DC voltage at the seventh time. In some embodiments, the second switch 128 remains activated at the seventh time. In some embodiments, the voltage at the third node 162 is less than the third DC voltage at the seventh time. In some embodiments, the third switch 138 remains activated at the seventh time.

In some embodiments, the voltage at the third node 162 reaches the third DC voltage at an eighth time. In some embodiments, the third switch 138 is deactivated at the eighth time. In some embodiments, the voltage at the fourth node 164 is not below the fourth DC voltage at the eighth time. In some embodiments, the fourth switch 148 remains deactivated at the eighth time. In some embodiments, the voltage at the first node 158 is less than the first DC voltage at the eighth time. In some embodiments, the first switch 118 remains activated at the eighth time. In some embodiments, the voltage at the second node 160 is less than the second DC voltage at the eighth time. In some embodiments, the second switch 128 remains activated at the eighth time.

In some embodiments, the voltage at the first node 158 reaches the first DC voltage at a ninth time. In some embodiments, the first switch 118 is deactivated at the ninth time. In some embodiments, the voltage at the fourth node 164 is not below the fourth DC voltage at the ninth time. In some embodiments, the fourth switch 148 remains deactivated at the ninth time. In some embodiments, the voltage at the third node 162 is not below the third DC voltage at the ninth time. In some embodiments, the third switch 138 remains deactivated at the ninth time. In some embodiments, the voltage at the second node 160 is less than the second DC voltage at the ninth time. In some embodiments, the second switch 128 remains activated at the ninth time.

In some embodiments, the voltage at the fourth node 164 decreases below the fourth DC voltage at a tenth time. In some embodiments, the fourth switch 148 is reactivated at the tenth time. In some embodiments, the voltage at the third node 162 is not below the third DC voltage at the tenth time. In some embodiments, the third switch 138 remains deactivated at the tenth time. In some embodiments, the voltage at the first node 158 is not below the first DC voltage at the tenth time. In some embodiments, the first switch 118 remains deactivated at the tenth time. In some embodiments, the voltage at the second node 160 is less than the second DC voltage at the tenth time. In some embodiments, the second switch 128 remains activated at the tenth time.

In some embodiments, the voltage at the fourth node 164 reaches the fourth DC voltage at an eleventh time. In some embodiments, the fourth switch 148 is deactivated at the eleventh time. In some embodiments, the voltage at the third node 162 is not below the third DC voltage at the eleventh time. In some embodiments, the third switch 138 remains deactivated at the eleventh time. In some embodiments, the voltage at the first node 158 is not below the first DC voltage at the eleventh time. In some embodiments, the first switch 118 remains deactivated at the eleventh time. In some embodiments, the voltage at the second node 160 is less than the second DC voltage at the eleventh time. In some embodiments, the second switch 128 remains activated at the eleventh time.

In some embodiments, the voltage at the second node 160 reaches the second DC voltage at a twelfth time. In some embodiments, the second switch 128 is deactivated at the twelfth time. In some embodiments, the voltage at the fourth node 164 is not below the fourth DC voltage at the twelfth time. In some embodiments, the fourth switch 148 remains deactivated at the twelfth time. In some embodiments, the voltage at the third node 162 is not below the third DC voltage at the twelfth time. In some embodiments, the third switch 138 remains deactivated at the twelfth time. In some embodiments, the voltage at the first node 158 is not below the first DC voltage at the twelfth time. In some embodiments, the first switch 118 remains deactivated at the twelfth time.

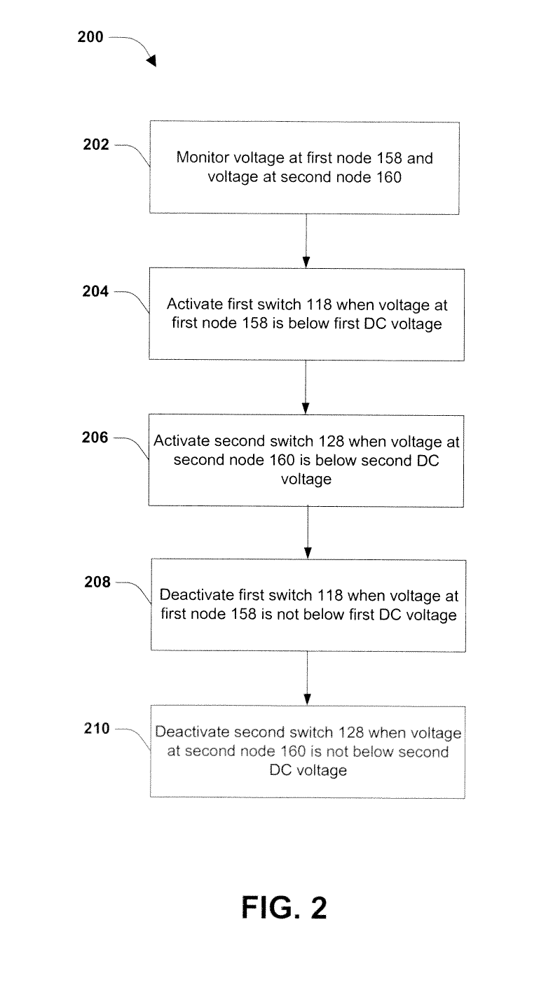

FIG. 2 illustrates a first method 200 for soft starting the SIMO DC-DC convertor so that a first DC voltage is established at the first node 158 and a second DC voltage is established at the second node 160. In some embodiments, at 202, a voltage at the first node 158 and a voltage at the second node 160 are respectively monitored. In some embodiments, at 204, at a first time, the first switch 118 is activated when the voltage at the first node 158 is below the first DC voltage. In some embodiments, at 206, at the first time, the second switch 128 is activated when the voltage at the second node 160 is below the second DC voltage. In some embodiments, the first time occurs when the SIMO DC-DC convertor is turned on. In some embodiments, at 208, at a second time, the first switch 118 is deactivated when the voltage at the first node 158 is not below the first DC voltage. In some embodiments, the second time occurs after the first time. In some embodiments, at 210, at a third time, the second switch 128 is deactivated when the voltage at the second node 160 is not below the second DC voltage. In some embodiments, the third time occurs after the first time.

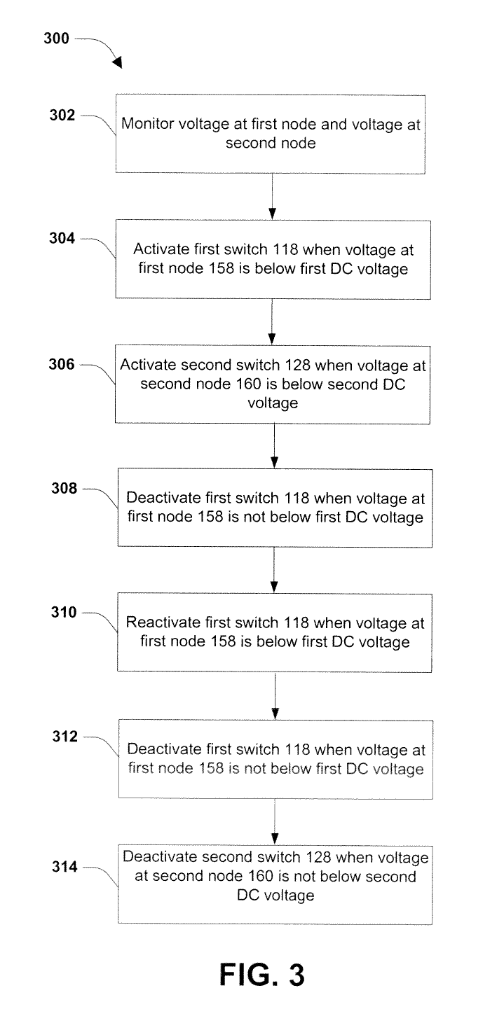

FIG. 3 illustrates a second method 300 for soft starting the SIMO DC-DC convertor so that a first DC voltage is established at the first node 158 and a second DC voltage is established at the second node 160. In some embodiments, at 302, a voltage at the first node 158 and a voltage at the second node 160 are respectively monitored. In some embodiments, at 304, at a first time, the first switch 118 is activated when the voltage at the first node 158 is below the first DC voltage. In some embodiments, at 306, at the first time, the second switch 128 is activated when the voltage at the second node 160 is below the second DC voltage. In some embodiments, the first time occurs when the SIMO DC-DC convertor is turned on. In some embodiments, at 308, at a second time, the first switch 118 is deactivated when the voltage at the first node 158 is not below the first DC voltage. In some embodiments, the second switch 128 is not deactivated at the second time. In some embodiments, the second time occurs after the first time. In some embodiments, at 310, at a fourth time, the first switch 118 is reactivated when the voltage at the first node 158 is below the first DC voltage. In some embodiments, the second switch 128 is not deactivated at the fourth time. In some embodiments, the fourth time occurs after the second time. In some embodiments, at 312, at a fifth time, the first switch 118 is deactivated when the voltage at the first node 158 is not below the first DC voltage. In some embodiments, the fifth time occurs after the fourth time. In some embodiments, at 314, at a third time, the second switch 128 is deactivated when the voltage at the second node 160 is not below the second DC voltage. In some embodiments, the third time occurs after the fifth time\.

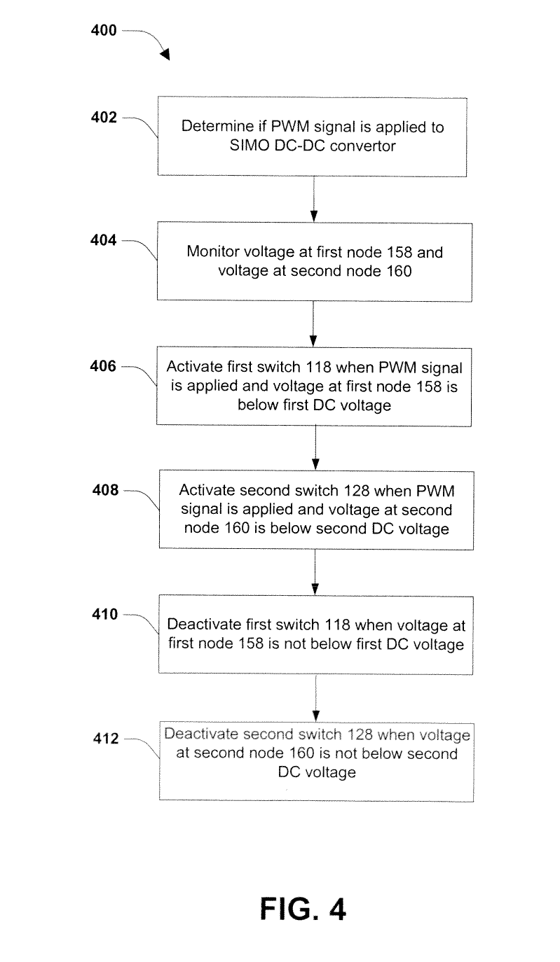

FIG. 4 illustrates a third method 400 for soft starting the SIMO DC-DC convertor so that a first DC voltage is established at the first node 158 and a second DC voltage is established at the second node 160. In some embodiments, at 402, it is determined if a PWM signal is applied to the SIMO DC-DC convertor. In some embodiments, the PWM signal being applied to the SIMO DC-DC convertor signifies that the SIMO DC-DC convertor is active. In some embodiments, at 404, a voltage at the first node 158 and a voltage at the second node 160 are respectively monitored. In some embodiments, at 406, at a first time, the first switch 118 is activated when the voltage at the first node 158 is below the first DC voltage and when the PWM signal is applied to the SIMO DC-DC convertor. In some embodiments, at 408, at the first time, the second switch 128 is activated when the voltage at the second node 160 is below the second DC voltage and when the PWM signal is applied to the SIMO DC-DC convertor. In some embodiments, at 410, at a second time, the first switch 118 is deactivated when the voltage at the first node 158 is not below the first DC voltage. In some embodiments, the second time occurs after the first time. In some embodiments, at 412, at a third time, the second switch 128 is deactivated when the voltage at the second node 160 is not below the second DC voltage. In some embodiments, the third time occurs after the second time. In some embodiments, the third time occurs before the second time.

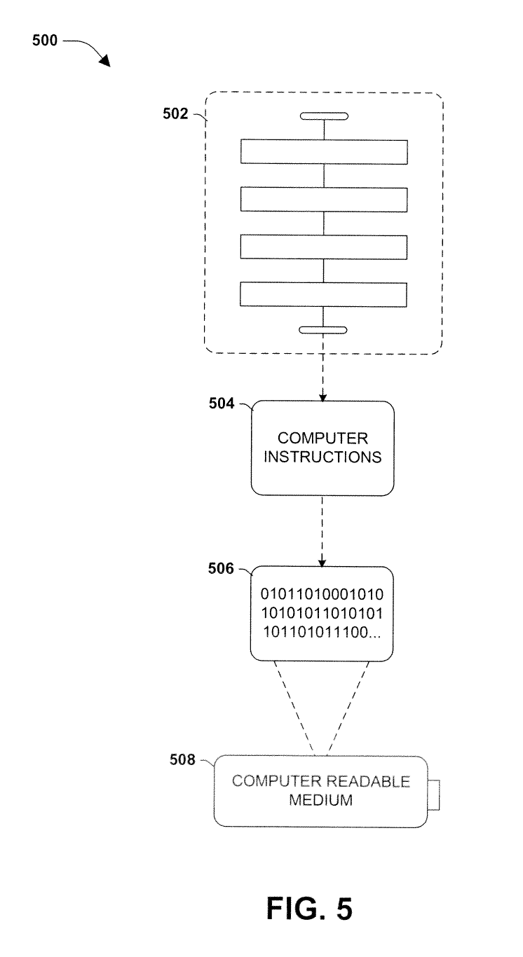

Still another embodiment involves a computer-readable medium comprising processor-executable instructions configured to implement one or more of the techniques presented herein. An example embodiment of a computer-readable medium and/or a computer-readable device that is devised in these ways is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506 in turn comprises a set of computer instructions 504 configured to operate according to one or more of the principles set forth herein. In one such embodiment 500, the processor-executable computer instructions 504 is configured to perform a method 502, such as at least some of the exemplary method 200 of FIG. 2, at least some of exemplary method 300 of FIG. 3 and/or at least some of exemplary method 400 of FIG. 4, for example. Many such computer-readable media are devised by those of ordinary skill in the art that are configured to operate in accordance with the techniques presented herein.

In some embodiments, a SIMO DC-DC convertor is provided. In some embodiments, the SIMO DC-DC convertor is configured to establish a first DC voltage at a first node and a second DC voltage at a second node. In some embodiments, the SIMO DC-DC convertor comprises an inductor, a first switch and a second switch. In some embodiments, the first switch is connected to a first side of the inductor and to the first node. In some embodiments, the first switch is configured to be activated when a voltage at the first node is below the first DC voltage. In some embodiments, the second switch is connected to the first side of the inductor and to the second node. In some embodiments, the second switch is configured to be activated when a voltage at the second node is below the second DC voltage.

In some embodiments, a method for soft starting a SIMO DC-DC convertor is provided. In some embodiments, the SIMO DC-DC convertor comprises an inductor, a first switch connected to a first node and a second switch connected to a second node. In some embodiments, the SIMO DC-DC convertor is configured to establish a first DC voltage at the first node and to establish a second DC voltage at the second node. In some embodiments, the method comprises monitoring a voltage at the first node and a voltage at the second node. In some embodiments, the method comprises activating the first switch at a first time when the voltage at the first node is below the first DC voltage. In some embodiments, the method comprises activating the second switch at the first time when the voltage at the second node is below the second DC voltage. In some embodiments, the method comprises deactivating the first switch at a second time, after the first time, when the voltage at the first node is not below the first DC voltage. In some embodiments, the method comprises deactivating the second switch at a third time, after the first time, when the voltage at the second node is not below the second DC voltage.

In some embodiments, a method for soft starting a SIMO DC-DC convertor is provided. In some embodiments, the SIMO DC-DC convertor comprises a first switch connected to a first node and a second switch connected to a second node. In some embodiments, the SIMO DC-DC convertor is configured to establish a first DC voltage at the first node and to establish a second DC voltage at the second node. In some embodiments, the method comprises determining if a PWM signal is applied to the SIMO DC-DC convertor. In some embodiments, the method comprises monitoring a voltage at the first node and a voltage at the second node. In some embodiments, the method comprises activating the first switch at a first time when the PWM signal is applied to the SIMO DC-DC convertor and the voltage at the first node is below the first DC voltage. In some embodiments, the method comprises activating the second switch at the first time when the PWM signal is applied to the SIMO DC-DC convertor and the voltage at the second node is below the second DC voltage. In some embodiments, the method comprises deactivating the first switch at a second time, when the voltage at the first node is not below the first DC voltage. In some embodiments, the method comprises deactivating the second switch at a third time, after the first time, when the voltage at the second node is not below the second DC voltage.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Various operations of embodiments are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A single inductor multiple output (SIMO) DC-DC convertor configured to establish a first DC voltage at a first node and a second DC voltage at a second node, comprising:
an inductor;
a first switch connected to a first side of the inductor and to the first node, the first switch configured to be activated when a voltage at the first node is below the first DC voltage; and
a second switch connected to the first side of the inductor and to the second node, the second switch configured to be activated when a voltage at the second node is below the second DC voltage.

2. The SIMO DC-DC convertor of claim 1, comprising:
a first transistor connected to a first voltage source and to a second side of the inductor;
a second transistor connected to a second voltage source and to the second side of the inductor; and
a first circuit connected to a gate of the first transistor and to a gate of the second transistor.

3. The SIMO DC-DC convertor of claim 2, the first transistor comprising a first NMOS transistor and the second transistor comprising a second NMOS transistor.

4. The SIMO DC-DC convertor of claim 2, a source of the first transistor connected to the first voltage source and a drain of the first transistor connected to the second side of the inductor.

5. The SIMO DC-DC convertor of claim 4, a source of the second transistor connected to the second voltage source and a drain of the second transistor connected to the second side of the inductor.

6. The SIMO DC-DC convertor of claim 5, the first circuit configured to receive a pulse-width modulation (PWM) signal.

7. The SIMO DC-DC convertor of claim 6, the first circuit configured to activate the first transistor when a voltage of the PWM signal is within a first voltage range and the first circuit configured to activate the second transistor when the voltage of the PWM signal is within a second voltage range, the first transistor not activated when the second transistor is activated and the second transistor not activated when the first transistor is activated.

8. The SIMO DC-DC convertor of claim 2, the first transistor configured to maintain a connection between the first voltage source and the second side of the inductor when the first transistor is activated.

9. The SIMO DC-DC convertor of claim 2, the second transistor configured to maintain a connection between the second voltage source and the second side of the inductor when the second transistor is activated.

10. The SIMO DC-DC convertor of claim 1, the first switch comprising one or more transistors and the second switch comprising one or more transistors.

11. The SIMO DC-DC convertor of claim 1, the first switch comprising an NMOS transistor and the second switch comprising an NMOS transistor.

12. A method for soft starting a single inductor multiple output (SIMO) DC-DC convertor, the SIMO DC-DC convertor comprising an inductor, a first switch connected to a first node and a second switch connected to a second node, the SIMO DC-DC convertor configured to establish a first DC voltage at the first node and to establish a second DC voltage at the second node, the method comprising:
monitoring a voltage at the first node and a voltage at the second node;
activating the first switch at a first time when the voltage at the first node is below the first DC voltage;
activating the second switch at the first time when the voltage at the second node is below the second DC voltage;
deactivating the first switch at a second time, after the first time, when the voltage at the first node is not below the first DC voltage; and
deactivating the second switch at a third time, after the first time, when the voltage at the second node is not below the second DC voltage.

13. The method of claim 12, the second time before the third time such that the second switch remains activated while the first switch is deactivated.

14. The method of claim 13, comprising reactivating the first switch at a fourth time before the third time, such that the first switch is reactivated without having deactivated the second switch.

15. The method of claim 14, comprising deactivating the first switch at a fifth time.

16. The method of claim 15, the fifth time before the third time such that the first switch is deactivated twice without having deactivated the second switch.

17. The method of claim 12, the first DC voltage not equal to the second DC voltage.

18. The method of claim 10, the second time not equal to the third time.

19. A method for soft starting a single inductor multiple output (SIMO) DC-DC convertor, the SIMO DC-DC convertor comprising a first switch connected to a first node and a second switch connected to a second node, the SIMO DC-DC convertor configured to establish a first DC voltage at the first node and to establish a second DC voltage at the second node, the method comprising:
determining if a pulse-width modulation (PWM) signal is applied to the SIMO DC-DC convertor;
monitoring a voltage at the first node and a voltage at the second node;
activating the first switch at a first time when the PWM signal is applied to the SIMO DC-DC convertor and the voltage at the first node is below the first DC voltage;
activating the second switch at the first time when the PWM signal is applied to the SIMO DC-DC convertor and the voltage at the second node is below the second DC voltage;
deactivating the first switch at a second time when the voltage at the first node is not below the first DC voltage; and
deactivating the second switch at a third time when the voltage at the second node is not below the second DC voltage.

20. The method of claim 19, comprising receiving the PWM signal at a first circuit of the SIMO DC-DC convertor.
